(19) United States
(12) Patent Application Publication
(10) Pub. No.: US 2009/0104314 A1
(43) Pub. Date: Apr. 23, 2009

(54) EDIBLE, BIODEGRADABLE PET FOOD CONTAINER AND PACKAGING METHOD

(76) Inventors: David A. Dellinger, Santa Barbara, CA (US); Elie Helou, JR., Santa Barbara, CA (US)

Correspondence Address: PERKINS COIE LLP, POST OFFICE BOX 1208, SEATTLE, WA, 98111-1208, US

(21) Appl. No.: 12/257,289

(22) Filed: Oct. 23, 2008

Related U.S. Application Data
(63) Continuation-in-part of application No. 10/608,441, filed on Jun. 27, 2003, now Pat. No. 7,481,645.
Application No. 10/608,441 is a continuation-in-part of application No. 10/928,602, filed on Aug. 26, 2004.
Application No. 10/928,602 is a continuation-in-part of application No. 11/285,508, filed on Nov. 21, 2005.
Application No. 11/285,508 is a continuation-in-part of application No. 10/928,602, filed on Aug. 26, 2004.
Application No. 10/928,602 is a continuation-in-part of application No. 12/168,049, filed on Jul. 3, 2008.
(60) Provisional application No. 60/982,345, filed on Oct. 24, 2007.
(60) Provisional application No. 60/498,129, filed on Aug. 26, 2003.
(60) Provisional application No. 60/498,396, filed on Aug. 27, 2003.
(60) Provisional application No. 60/947,934, filed on Jul. 3, 2007.

(51) Int. Cl. A23K 1/00; A23K 1/18

(52) U.S. Cl. 426/72; 426/138; 426/104; 426/282; 426/115; 426/661

(57) ABSTRACT

One embodiment of the present invention is an edible non-human animal container or pet food container comprising water, pregelatinized and native starch, a cross-linker natural fibers, a wax emulsion, a mold release agent, a flavoring agent, and a coloring agent, food grade materials, and wherein the container is of a shape that is attractive to non-human animals.

### CROSS-REFERENCE TO RELATED APPLICATIONS

This application is a continuation in part of and claims the benefit of the following applications, all of which are incorporated herein by reference:

1. U.S. Provisional Patent Application No. 60/982,345, filed Oct. 24, 2007 [40134.8004.US00];
2. U.S. patent application Ser. No. 10/608,441, filed Jun. 27, 2003 [40134.8001.US00];
3. U.S. patent application Ser. No. 10/928,602, filed Aug. 26, 2004 [40134.8002.US02], which claims the benefit of U.S. Provisional Patent Application Nos. 60/498,129, filed Aug. 26, 2003 [40134.8002.US00] and 60/498,396, filed Aug. 27, 2003 [40134.8002.US01];
4. U.S. patent application Ser. No. 11/285,508, filed Nov. 21, 2005 [40134.8002.US03], which is a continuation in part of U.S. patent application Ser. No. 10/928,602, filed Aug. 26, 2004 [40134.8002.US02], which claims the benefit of U.S. Provisional Patent Application Nos. 60/498,129, filed Aug. 26, 2003 [40134.8002.US00] and 60/498,396, filed Aug. 27, 2003 [40134.8002.US01]; and
5. U.S. patent application Ser. No. 12/168,049, filed Jul. 3, 2008 [40134.8003.US01], which claims the benefit of U.S. Provisional Patent Application No. 60/947,934, filed Jul. 3, 2007 [40134.8003.US00].

### BACKGROUND

Conventional disposable food service items are commonly made from paper or paperboard (commonly coated or impregnated with a polymeric water-proofing material such as wax or polyethylene), or one of a variety of plastics (polystyrene is the most common). In addition, ovenable disposables are made from aluminum or CPET, commonly known as dual ovenable plastic.

During the introduction of Biosphere biodegradable compostable products, it was found that children often expressed a desire to eat the articles presented. When asked, adults also expressed an interest in edible packaging or food-service items. Edible, starch-based food service items which were greeted with considerable public enthusiasm at the 1994 Winter Olympic Games in Lillehammer, Norway; after use, those items were fed to livestock, eliminating a large source of waste. Home and industrial bakers have expressed a desire for edible molding devices for cakes, cupcakes, muffins, tarts, pies, and the like, to replace the metal and paper items currently in use.

In addition to the intrinsic appeal of edible packaging materials to children and other consumers, there is a growing recognition that the environmental costs of using “cheap” plastic materials for packaging may be quite high. The expected lifetime of a polystyrene cup, for example, is about 500 years, and each American disposes an average of about 100 cups per year. Polystyrene is made by chemical processing of benzene and ethylene, both byproducts of the petroleum industry, and thus both nonrenewable resources. Although the environmental record of the petroleum industry has improved greatly since the mid-twentieth century, extraction and processing of petroleum for fuel and chemical production remain recognized environmental problems. Questions have also been raised about the wisdom of using a limited natural resource (fossil hydrocarbon stocks) to produce disposable items (which exacerbate waste handling problems) rather than reserving the resource for production of durable goods.

United States Government sources indicate that packaging (of all types) makes up 32 percent of the municipal solid waste stream by weight. Food packaging makes up about 9 percent of the waste stream. Costs of disposal of municipal wastes are likely to increase as landfill regulations become more stringent, current sites are filled and replaced by (usually) more distant sites, and waste transportation costs increase (along with fuel costs).

Pet food packaging also contributes appreciably to the waste stream. The total annual worldwide market for pet food packaging has been estimated to exceed $500 million, with increasing emphasis on smaller packaging, including portion-sized packages. As in all industries, the smaller the quantity of product per unit sold, the greater the ratio of packaging volume to product volume; the quantity of pet food packaging being used is thus growing at a higher rate than the quantity of pet food itself.

Materials that are impervious to moisture and impermeable to oxygen and other gasses include conventional plastics, metals, glass, and plastic-coated paper or paperboard. Of these, metal, glass, paperboard, and molded plastics typically provide structural protection of the packaged items as well as barrier properties, whereas plastic films and plastic-coated papers mainly provide barrier protection rather than structural protection. Typically much more mass is required to obtain the structural rigidity required of packaging than is required to obtain suitable barrier properties alone. None of these materials are biodegradable or compostable. To the extent that they enter the disposal waste stream (i.e., that they are not recycled), these materials are persistent; they will remain in landfills even where oxygen and moisture are provided to encourage biodegradation.

In addition to waste disposal concerns, some current research suggests that certain chemicals (phthalates and other plasticizers) used in the manufacture of plastics may have detrimental effects on the environment and on human reproductive systems, even at extremely low concentrations, by affecting the endocrine (hormone) system in humans and many other animal species. The observations suggest that, in both wildlife and humans, very low concentrations of these compounds can mimic or interfere with hormones that play important roles in embryonic development, resulting in effects such as hermaphroditism in gastropods; feminization of fish, alligators, and some mammals; malformations or morbidity in amphibians, fish, and birds; and various effects in human developmental and reproductive biology. Although the research and many of the conclusions that have been drawn from it are controversial, the FDA and some Japanese and European regulatory agencies are considering bans or additional regulations on certain phthalates. Regardless of how this debate is resolved in the future, there is currently increasing public concern about the safety of plastics and the plasticizers that are used to improve their physical properties.

The desire to use disposable packaging materials that are biodegradable and compostable has been steadily increasing in the last decade. As recently as March, 2003, Taiwan outlawed the use of polystyrene foam in disposable packaging. China's major cities (e.g., Beijing and Shanghai) have also outlawed the use of polystyrene foam in disposable packaging. Commenting on solid waste policy in the United States, the web site of American Society of Civil Engineers says that “the problem of over consumption should be addressed, with the goal of reducing the production and consumption of unnecessary goods, packaging and throwaways. Toxic materials used in products and packaging and produced as byproducts in production processes should be minimized.”

Unlike plastics, paper and paperboard are made from wood pulp, which is a renewable material. The regeneration time, however, for wood fiber—the time required to grow a tree—is substantial, and the chemical processing needed to produce white (“bleached”) fibers has been recognized to be detrimental to the environment. The use of unbleached and recycled fibers helps alleviate these environmentally detrimental activities, but the use of slow-growing trees as a fiber source when many agricultural byproduct sources are available is in itself questionable.

Further, in the current art, starch-based food service articles typically contain two or three major phases: a matrix material (mainly starch) that contains inorganic filler materials and/or fibrous materials. The mechanical properties of the starch matrix material are critical to the performance of these articles. Baked unmodified starch is typically quite fragile and brittle when dry, but relatively soft and pliable when the starch contains 5% to 10% moisture. In current practice, fiber is often added to the formulation to increase the flexural strength and fracture energy of starch-based items, especially during the period immediately after demolding, when the moisture content of the starch is very low. Even with the addition of significant amounts (10% or more) of fiber, however, starch-based articles are commonly very brittle immediately after demolding or when stored for extended periods in dry environments (heated buildings in winter, air conditioned buildings in summer, desert environments any time of year). Brittle failure of starch-based articles thus continues to present problems during the manufacturing process (especially before coatings or laminated films are applied) and when the articles are used in dry environments.

Moreover, in the current art, inorganic mineral fillers (e.g., calcium carbonate, silica, calcium sulfate, calcium sulfate hydrate, magnesium silicate, micaceous minerals, clay minerals, titanium dioxide) are often included in formulations used to produce starch-based biodegradable food service articles. These fillers are not, however, biodegradable. Marketing claims made for products using these materials as fillers point out that the materials are natural, renewable, and environmentally benign. However, there are inherent environmental costs associated with the mining (or synthesis) and processing of all inorganic filler materials.

Finally, in the current art, the most commonly used fiber in starch-based food service articles is wood-pulp fiber (similar to the paper based articles). As the main source material for the paper industry, it is readily available, is consistent in quality and material properties, and has the main properties needed to serve as structural elements in the finished food service articles. The use, however, of slow-growing trees as a fiber source when many agricultural byproduct sources are available is, as set forth above, in itself questionable.

Accordingly, there is a need for an improved system for producing edible, biodegradable, and compostable disposable items that can serve the full range of uses to which containers, plates, trays, and bowls are usually put. Consumers clearly would benefit from the introduction of a new edible food service and packaging material. Society at large would clearly benefit from an overall reduction in the amount of food packaging materials in the municipal solid waste stream.

Further, there is a need to reduce the proportion of persistent, non-biodegradable food packaging in the municipal waste stream. Development of packaging systems that combine edible, compostable, and biodegradable materials for structural rigidity with minimal amounts of plastic film or plastic-coated paper for protection from water, water vapor, oxygen, and contaminants would be beneficial.

Further, development of packaging materials made entirely from natural, edible ingredients would reduce both environmental and human health effects of plasticizers, to whatever extent they are eventually shown to occur. Until the debate over the issue is resolved, edible packaging materials may serve as an alternative to plastics for concerned consumers.

There is also a need for an improvement in the current art that will replace mineral fillers with fully biodegradable and renewable plant-based organic materials that serve the same role as traditional mineral fillers. Even greater benefit is available if the filler material is currently produced as a byproduct of the production of another agricultural material.

Finally, there is also a need for methods and formulations that incorporate fibrous materials from annually grown non-wood plants, and particularly from materials that are byproducts of commodities already in production.

### SUMMARY

In certain embodiments, a mix formulation for the production of edible, biodegradable, and compostable pet food packaging and service items and methods for use of said formulations are provided. In certain embodiments of the present invention an edible non-human animal food container comprising starch, water, and processed fibrous material is provided. In one embodiment, the starch may be pregelatinized starch, uncooked starch, native starch, water-resistant starch, or a combination thereof. In another embodiment, the processed fibrous material may comprise fibers having a length of more than about 4 mm to about 25 mm, fibers having a length of about 0.5 mm to about 5 mm, and/or fibers having a length of less than about 0.5 mm. In yet another embodiment, the edible non-human animal food container may further comprise a protein or a polymer, wherein the protein or polymer may reduce the brittleness of the edible pet food container. In still another embodiment, the edible non-human animal food container may further comprise a wax, a wax emulsion, a mold-releasing agent, a coloring agent, a flavoring agent, a pest control agent, a vitamin, or combinations thereof. The edible non-human animal food container may be of any desired shape, for example, a shape similar to the shape of a bone, a fish, or a rodent.

In certain embodiments of the present invention a pre-packaged non-human animal feeding article for feeding a non-human animal, comprising: (1) an edible non-human animal food container comprising starch, water, and processed fibrous material; (2) a quantity of non-human animal food contained within the edible non-human animal food container; and (3) optionally, a packaging material, is further provided.

Also provided is a method for making a baked article, comprising: providing a mold apparatus comprising a cavity in the shape of a desired baked article and a gap for venting vapor or steam from the mold apparatus; applying a liquid or semi-liquid mixture to the mold apparatus; and heating the mold apparatus, whereby forming a skin at the interface between the liquid or semi-liquid mixture and the surface of the mold apparatus, wherein the skin is permeable or semi-permeable to the vapor or steam formed during the heating process, and wherein the skin and the gap, in combination, allows escape of steam or vapor from the cavity to the exterior of the mold apparatus.

Other features and advantages of the present invention will become apparent from the following detailed description. It should be understood, however, that the detailed description and the specific examples, while indicating the preferred embodiments of the present invention, are given by way of illustration only, since various changes and modifications within the spirit and scope of the present invention will become apparent to those skilled in the art from this detailed description.

### FIGURES

FIG. 1 shows a representative method for packaging individual serving size portions of pet food in accordance with embodiments of the present invention.

FIG. 2 shows three perspective views of different size pet food containers in accordance with embodiments of the present invention.

FIG. 3 shows two perspective views of an edible pet food container in the shape of a fish in accordance with embodiments of the present invention.

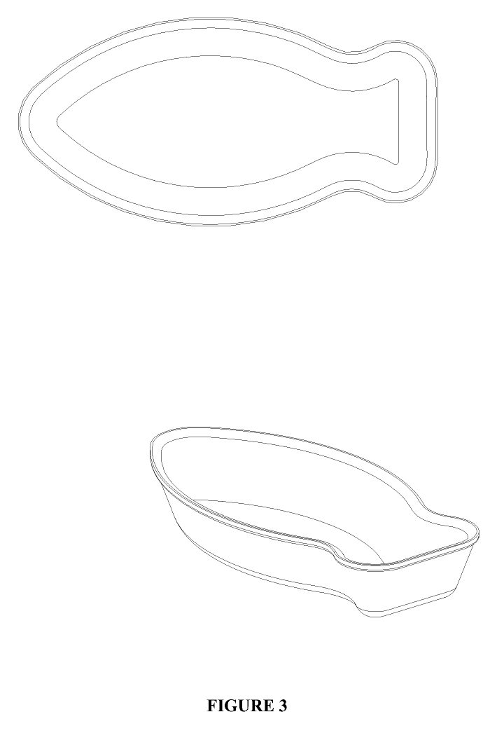

FIG. 4 shows two perspective views of an edible pet food container in the shape of a mouse in accordance with embodiments of the present invention.

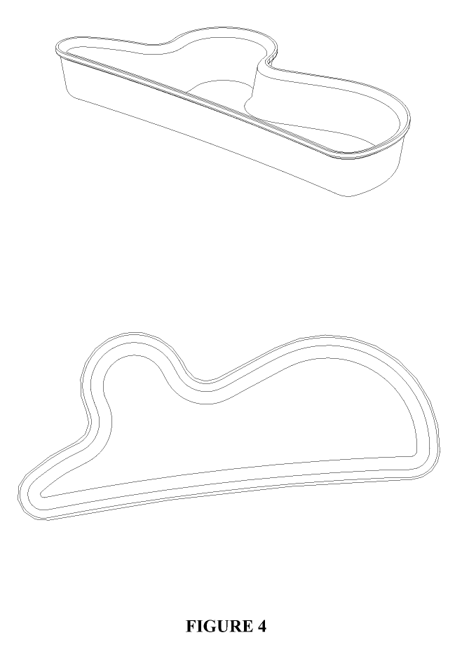

### DETAILED DESCRIPTION

In order to fully understand the manner in which the above-recited details and other advantages and objects according to the invention are obtained, a more detailed description of the invention will be rendered by reference to specific embodiments thereof. The following description of the invention is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all of the items in the list, or (c) any combination of items in the list.

One embodiment of the present invention provides packaging material that is edible and is much stronger than standard ice cream cone formulations, while remaining functional in oven and microwave environments. Typical envisioned applications for the present embodiment include stronger ice cream cones, pie shells, muffin trays, hot dog holders, candy trays, ice cream trays, cookie holders, and dessert trays. Products with enhanced moisture resistance can be provided by coating the tray with an edible, moisture resistant coating. Where long term storage of food products requires a sealed moisture and oxygen barrier, conventional coated paper or plastic film materials can be used for barrier materials, with a rigid edible, compostable, and biodegradable insert acting to hold and protect the food items.

Pet food containers can also be produced according to the present embodiment. These containers are not only edible, but (unlike many conventional packaging materials) are safe for pets' teeth as well. This new pet edible packaging can be flavored to act as a “treat” after the pet has finished eating the meal, or served as part of the meal itself. Elimination of pet food packaging would provide pets with an additional source of dietary fiber, reduce the amount of pet food packaging material in the waste stream currently being sent to landfills, and increase the overall efficiency of pet food delivery by eliminating waste packaging material.

A formulation according to the present invention from which edible packaging items (containers, plates, trays, bowls, cones, and cups, as well as other novel shapes) can be produced is provided comprising water; starch; optionally several natural fibrous materials used in combination both as structural elements (at several size scales) in the baked items and as inexpensive organic replacements for inorganic fillers; optionally proteins and natural polymeric compounds to reduce the brittleness of the articles produced for use in dry environments and to prevent breakage immediately after forming when the items are typically dry; optionally wax or wax emulsions to increase water-resistance of the finished items; optionally a mold release agent to reduce adhesion between baked parts and the mold system; and optionally food grade coloring and/or flavoring agents to increase the sensory appeal of the items.

There are several sources available for the starch component. Sources of starch may include, but are not limited to, plant sources such as tubers, roots, seeds, and/or fruits of plants, and specific plants sources may include corn, potato, tapioca, rice, or wheat or similar, or animal sources, namely glycogen. In some embodiments, starch is a combination of both pregelatinized and uncooked or native starches. In some embodiments, the pregelatinized starch has a concentration in the range of about 0% to about 30% by weight of total starch in the formulation, and more preferably more than 0% to less than 30%, or 3% to about 20%, or more than 5% to less than or about 20%, or more than 7% to less than 15%, or more than 5% to less than 15% by weight of total starch in the formulation. Food-grade starches (pregelatinized or uncooked) that have been modified by cross-linking, stabilization, or addition of lipophilic functional groups may be included to increase resistance of the products to softening when exposed to aqueous foods.

In some embodiments, the starch can be a water-resistant starch, and these starches can be a modified starch, an unmodified starch such high-amylose starch, or a combination thereof. In certain embodiments, the water-resistant starch can be, e.g., a chemically modified starch such as alkenyl succinic anhydride modified starch, acetic anhydride modified starch, vinyl acetate modified starch, acrolein modified starch, epichlorohydrin modified starch, phosphorus oxychloride modified starch, sodium trimetaphosphate modified starch, or propylene oxide modified starch, or the like; an unmodified starch such as high-amylose starch; any other starch known in the art which has water-resistant properties; or a combination thereof. For example, the starch component can comprise natural starch, pre-gelatinized starch, high-amylose starch, or a combination thereof. In some embodiments, at least a portion of the starch component can be comprised of one or more water-resistant starches. The water-resistant starches may either be standard starches that have been chemically modified to be water resistant such as, e.g., alkenyl succinic anhydride modified starch, acetic anhydride modified starch, vinyl acetate modified starch, acrolein modified starch, epichlorohydrin modified starch, phosphorus oxychloride modified starch, sodium trimetaphosphate modified starch, or propylene oxide modified starch, or the like, or starches that are water resistant in their native, unmodified state such as high amylase starch; or any other starch known in the art which has water-resistant properties; or a combination thereof; In certain embodiments, the water-resistant fraction of the starch component may include chemically modified water-resistant starch, naturally water resistant high amylose starch, or a combination thereof. Use of water-resistant starches as a portion of the starch component increases the moisture resistance of the finished products.

Insolubilizing compounds (or cross-linking agents) have been used in the paper industry in the preparation of water-resistant coatings on paper to increase printability and decrease susceptibility to moisture. Insolublizers that may be used in the present embodiment include, but are not limited to, aqueous solutions containing modified ethandial, glyoxal-based reagents, ammonium zirconium carbonate, potassium zirconium carbonate, and polyamide-epichlorohydrine compounds. The amount of active ingredient of the insolubilizer used is up to about 20% by weight of the starch (including both native and pregelatinized starch), and is more preferred in the range from about 0.1% to about 20% by weight of starch, depending on the cross-linking system used and the specific application.

It has been found that in some cases in order to maximize the effectiveness of the insolubilizer used, it is necessary to adjust the pH of the formulation before adding the insolubilizing compound. It has also been found that depending upon the specific mix formulation some insolubilizer compounds react with the mix at low temperatures causing the mix to become too thick prior to molding. In such cases an insolubilizer with the desired properties should be selected.

Proteins and natural polymeric compounds may include, but are not limited to preparations made from casein, soy protein isolate or concentrate, or similar such preparations. One such preparation can be prepared in the following three steps: 1) cooking a solution of casein or soy protein isolate in water (about 10% by weight) as per usual manufacturer's recommendations (generally, hydrating the protein by soaking, then gradually raising the temperature and pH of the solution to 180° F. and pH=9 to 9.5, then holding the solution at 180° F. for 15 minutes); 2) cooling the preparation to room temperature; and optionally, 3) adding a preservative and blending thoroughly. The preferred concentration of preservative in the preparation is about 0.1% or less, depending on the shelf life required for the protein solution, the concentration of protein required in the final product, and the limits imposed by government regulations on the dosages of preservative compounds in edible materials. In certain embodiments, latex is added and the preferred ratio of latex to casein in the preparation is between about 1:1 to 2:1 (solids:solids), and a more preferred ratio is in a range from about 1.2:1 to about 1.8:1, and a most preferred ration is about 1.48:1. The ratio of casein to latex, however, may be adjusted according to the specific needs of the containers to be produced.

Other proteins may also be used in combination with the casein or soy protein preparation or separately to improve the water-resistant properties of the containers. For example, such proteins may include albumen, gelatin, or the like.

Several natural fibrous materials may be used in combination both as structural elements (at several size scales) in the baked items and or as inexpensive organic fillers. Fiber elements are used both to control the molding characteristics of the wet batter and to enhance the structural stability of the finished food service articles. Although there is a continuum of fiber lengths and fiber aspect ratios used in the formulation, the fibrous portion of the formulation can be in a general sense separated into three classes (based on fiber length) that serve different functions. Long or very long (4 to 25 mm or longer) fibers or composite fiber elements are used to form a meshwork that helps prevent defects from forming in the batter as it expands in the mold. Medium-length fibers (0.5 to 5 mm) also help control the flow characteristics of the wet batter, and serve to increase the toughness of the finished food service articles, preventing fracture during handling and during normal use. Short fibers (<0.5 mm) serve mainly as a means to introduce readily biodegradable material into the formulation, i.e., filler material that is more water-resistant than the starch-based matrix that contains them. (All types of fiber provide this functionality, but the presence of the medium, long, and very long fibers are required for the molding, handling and usage characteristics they provide, whereas the short fiber elements are present primarily for the contribution to water-resistance that they make.) Preferably, a dispersion of the fibers in a composition for making a container are such that the fibers are substantially separated from one another throughout a starch based matrix.

Optionally, the shorter fibers may be used in conjunction with, or replaced by other filler materials imparting the same advantages as the shorter fibers. For example, such filler materials may include both organic and inorganic aggregates such as calcium carbonate, silica, calcium sulfate, calcium sulfate hydrate, magnesium silicate, micaceous minerals, clay minerals, titanium dioxide, talc, etc. The concentration of aggregate and/or short fibers may be in a range from about 0% to about 25% by dry weight of the formulation, in a range from about 2.5% to about 20% by total dry weight of the formulation, in a range from about 5% to about 15% by total dry weight of the formulation, in a range from more than 5% to about 20% by total dry weight of the formulation, or in a range from about 7% to about 17% by total dry weight of the formulation, or in a range from more than 7% to about 17% by total dry weight of the formulation.

In one aspect of the present embodiment, the organic filler material may include, for example, ground nut shells such as walnut shells; ground wood such as wood flour; ground cellulose such as ground bamboo pulp; or any combination thereof. The organic filler material can result in fibrous matter comprising short fibers. The organic filler material may be used alone as the filler material or may be combined with other filler materials. When used alone the preferred concentration of an organic filler material, such as for example ground walnut shells is about 8% by dry weight.

Fibers from several sources are typically included in the formulation. Relatively high quality fibers from grass or reed species provide the mid-length fibers that contribute most to the structural stability and resilience if the finished articles. The long to very long fibers or fiber composites may come from lightly processed agricultural byproducts, e.g., stalk or husk materials that have been chopped, ground, or milled to an appropriate size, or they can come from traditional sources of long cellulose fiber, e.g., cotton or cotton linters. Under appropriate processing conditions (e.g., hammer or knife milling), these materials can also provide a considerable amount of the very short fiber that serves to replace starch and add water resistance to the finished article. Fibrous material in the form of ground wood, e.g., wood flour; ground cellulose, e.g., ground bamboo pulp; ground nut shells (or other very hard, lignin-rich plant materials); or any combination thereof, may also serve as organic, relatively water resistant, biodegradable fibers that replace conventional filler materials.

Moreover, these other sources of fiber suitable as structural elements in starch-based food service articles are readily available. Some of these are from fast-growing plants that can be broadly characterized as grasses or reeds, such as kenaf and bamboo, which provide fiber with smaller associated environmental costs than taking fiber from trees. A growing segment of the fiber industry is based on the use of fiber from these plants. In many cases the quality and consistency of fibers taken from these plants (after processing) is as good as that provided by the wood pulp industry. In addition, fiber is also widely available as a by-product of agricultural production. Stalks, stems, and husks from cereal grains, for example, are a ready source of fibrous material that, while not as high in quality as the fiber taken from wood or the better grass species, is extremely cheap and, as a by-product, has essentially no additional environmental cost (beyond whatever environmental costs are associated with the production of the main crop).

The fibrous materials included in the formulations described here vary greatly in both fiber length and fiber aspect ratio. Overall, however, it is preferred that the materials have an average fiber length that is less than about 2 mm and an average aspect ratio that is in the range of about 5:1 to 25:1.

The preferred wax or wax emulsions in the formulation, used to increase water-resistance, is a stable aqueous emulsion usually made of carnauba, candelilla, rice bran, paraffin, or any other food-grade wax: vegetable waxes are preferred over animal and mineral waxes, and natural waxes are preferred over synthetic varieties. The wax type is selected based on the particular application and desired properties of the final product. The emulsion is usually prepared by means of emulsifying agents and mechanical agitation. Examples of wax emulsions suitable for use in the present formulation include emulsified carnauba wax and emulsified candelilla wax. Emulsifiers include all of those permitted for food applications, including (but not limited to) sorbitan monostearate, Polysorbate 60, Polysorbate 65, Polysorbate 80, food-grade gums (e.g., arabinogalactan, carrageenan, furcelleran, xanthan), stearyl monoglyceridyl citrate, succistearin, hydroxylated lecithin, and many other compounds. In the alternative to wax, one may use an additive component or emulsion thereof in an amount ranging from more than 0% to about 15% or from about 0.5% to about 10% on a dry weight basis. The additive component can comprise an epoxidized vegetable oil, a hydrogenated triglyceride, poly(vinyl acetate), poly(vinylacetate-ethylene) copolymer, poly(ethylene-vinyl acetate) copolymer, or a combination thereof.

A mold release agent, or abherent, is provided to reduce adhesion between baked parts and the mold system. Examples of specific mold release agents that are suitable for use in the present formulation include, but are not limited to metal stearate compounds (e.g., aluminum, magnesium, calcium, potassium, sodium, or zinc stearates), fatty acids (e.g., oleic acid, linoleic acid), fats, oils, or similar materials, or a combination of any of the foregoing. The coloring agents preferred for use in the present formulation are water insoluble pigment types considered safe for use in food products (e.g., iron oxides, ultramarines, chromium-cobalt-aluminum oxides, ferric ammonium ferrocyanide, ferric ferrocyanide, manganese violet, carbazole violet). Alternatively, aluminum lake colorants, water-soluble food dyes, and combinations of pigments, or combinations of pigments with lakes and/or dyes may be used for some applications.

In certain embodiments, novel compositions and methods used to produce a biodegradable, starch-based, water-resistant articles of manufacture are provided. Some embodiments are directed to a composition comprising a biodegradable fiber component in an amount ranging from about 5% to about 40% on a dry weight basis, starch component in an amount ranging from about 40% to about 94.5% on a dry weight basis, and an additive component in an amount ranging from more than 0% to about 15% on a dry weight basis. The additive component can comprise an epoxidized vegetable oil, a hydrogenated triglyceride, poly(vinyl acetate), poly(vinyl acetate-ethylene) copolymer, poly(ethylene-vinyl acetate) copolymer, or a combination thereof. In certain embodiments, the additive component may be present in an amount ranging from about 0.5% to about 10% on a dry weight basis.

In some embodiments, the biodegradable fiber component comprises a natural fiber, and the natural fiber can comprise a woody fiber, a non-woody fiber, or an animal fiber. In some embodiments, the biodegradable fiber component comprises a biodegradable synthetic fiber.

In some embodiments, the starch component can comprise an organic filler material having a ratio of starch to filler that ranges from about 10:1 to about 1:1, with the ratio of starch to filler typically having a value of about 3:1.

In some embodiments, the additive can be present in an amount ranging from about 2% to about 5%. In some embodiments, the additive component is a hydrogenated triglyceride, an epoxidized vegetable oil, or a polymer selected from the group consisting of poly(vinyl acetate), poly(vinyl acetate-ethylene) copolymer, and poly(ethylene-vinyl acetate) copolymer.

Some embodiments are directed to an aqueous mixture comprising a composition taught herein, wherein the mixture can contain water in a quantity sufficient to allow for shaping of the composition into a form that creates a biodegradable, disposable, and water-resistant article of manufacture when heated at a sufficient temperature and for a sufficient time. In some embodiments, the amount of water ranges from about 40% to about 80%. In some embodiments, the starch component comprises a combination of native starch and pre-gelatinized starch, and the ratio of the fiber to pre-gelatinized starch ranges from about 1.5:1 to about 3:1. The compositions can further comprise magnesium stearate, a wax, a cross-linking agent, or any combination thereof.

Some embodiments are directed to a method of creating a biodegradable, starch-based, water-resistant article of manufacture. The method comprises adding an aqueous mixture comprising a composition taught herein to a mold apparatus having a cavity. The mixture is heated in the mold apparatus at a sufficient temperature and for a sufficient time for the mixture to be a stable form having a skin formed on the outer surface of the mixture where the mixture contacts the surface of the cavity during the heating. The mold apparatus comprises at least one gap such that vapor can exit the cavity of the mold though the gap without substantial loss of the mixture through the gap. And, in some embodiments, the material fills the mold cavity by in situ expansion during heating.

Some embodiments are directed to an article of manufacture comprising the compositions taught herein, wherein the article of manufacture can be biodegradable and water-resistant and, in some embodiments, the article of manufacture can be compostable. In some embodiments, the article of manufacture can be a food service product, a packaging material, or a combination thereof. In some embodiments, the article of manufacture is an approved food product that is edible.

Some embodiments are directed to a method of creating a biodegradable, starch-based, water-resistant article of manufacture. The method comprises preparing a mixture of a biodegradable fiber component and a starch component. The biodegradable fiber component can be in an amount ranging from about 5% to about 40% on a dry weight basis, and the starch component can be in an amount ranging from about 40% to about 94.5% on a dry weight basis. An additive component is added to the mixture in an amount ranging from about 0.5% to about 10% on a dry weight basis. And, the additive component can comprise a poly(vinyl acetate), poly(vinyl acetate-ethylene) copolymer, poly(ethylene-vinyl acetate) copolymer, or a combination thereof. An aqueous component is added to the mixture to create an aqueous composition, wherein the aqueous component comprises water in a quantity sufficient to allow for shaping of the composition into a desired form. The desired form is heated at a sufficient temperature and for a sufficient time to create a biodegradable, disposable, and water-resistant article of manufacture from the composition.

Some embodiments are directed to a method of creating a biodegradable, starch-based, water-resistant article of manufacture having an improved strength. The method comprises preparing a mixture comprising a biodegradable fiber component and a starch component, wherein the biodegradable fiber component is in an amount ranging from about 5% to about 40% on a dry weight basis, and the starch component is in an amount ranging from about 40% to about 94.5% on a dry weight basis. An additive component is added to the mixture in an amount ranging from about 0.5% to about 10% on a dry weight basis, wherein the additive component comprises an epoxidized vegetable oil, poly(vinyl acetate), poly(vinyl acetate-ethylene) copolymer, poly(ethylene-vinyl acetate) copolymer, or a combination thereof. An aqueous component is added to the mixture to create an aqueous composition, wherein the aqueous component comprises water in a quantity sufficient to allow for shaping of the composition into a desired form. The desired form is heated at a sufficient temperature and for a sufficient time to create a biodegradable, disposable, and water-resistant article of manufacture from the composition.

Some embodiments are directed to a composition comprising a biodegradable fiber component in an amount ranging from about 5% to about 40% on a dry weight basis, and a water-resistant starch component in an amount ranging from about 40% to about 94.5% on a dry weight basis. In such embodiments, the water-resistant starch can be, e.g., a chemically modified starch such as alkenyl succinic anhydride modified starch, acetic anhydride modified starch, vinyl acetate modified starch, acrolein modified starch, epichlorohydrin modified starch, phosphorus oxychloride modified starch, sodium trimetaphosphate modified starch, or propylene oxide modified starch, or the like; an unmodified starch such as high-amylose starch; or a combination thereof; or any other starch known in the art which has water-resistant properties. In some embodiments, the composition further comprises an additive component in an amount ranging from about 0.5% to about 10% on a dry weight basis, wherein the additive component comprises an epoxidized vegetable oil, a hydrogenated triglyceride, poly(vinyl acetate), poly(vinyl acetate-ethylene) copolymer, poly(ethylene-vinyl acetate) copolymer, or a combination thereof.

In certain embodiments, compositions may be biodegradable, compostable, or a combination thereof, and can be used to produce articles that degrade in the same manner. In some embodiments, a biodegradable material can decompose into simple compounds such as carbon dioxide, methane, water, inorganic compounds and biomass, where the predominant mechanism is the enzymatic action of micro-organisms. In some embodiments, a biodegradable material can decompose rapidly by microorganisms under natural conditions, for example, under aerobic and/or anaerobic conditions. In some embodiments, a biodegradable material can be reduced to monomeric components when exposed to microbial, hydrolytic, and/or chemical actions. Under aerobic conditions, the biodegradation can transform the material into end-products that include carbon dioxide and water. Under anaerobic conditions, the biodegradation can transform the materials into end-products that include carbon dioxide, water, and methane. In some embodiments, biodegradation is referred to as mineralization.

In some embodiments, biodegradation can be distinguished from compostability in that a material that is biodegradable is simply degraded by biological activity, especially enzyme action, leading to significant change of chemical structure of material with no time limit. Compostability, on the other hand, can be a property of a biodegradable material. For a material to be compostable, in some embodiments, the material can be biodegraded in a compost system and completes its biodegradation during the end use of the compost. The criteria that identify useful compost include, for example, very low heavy metal content, no ecotoxicity, and no obvious distinguishable residues.

There are several tests available to determine whether a composition is biodegradable, compostable, or both biodegradable and compostable. The ASTM definition for compostability, for example, can be used in some embodiments. The ASTM definition states that a compostable material, for example, is a material that is “capable of undergoing biological decomposition in a compost site as part of an available program, such that the material is not visually distinguishable and breaks down into carbon dioxide, water, inorganic compounds, and biomass at a rate consistent with known compostable materials”. In some embodiments, compostability can be measured per ASTM D-5338 using the Tier Two Level testing per ASTM D 6400. In comparison, the European definition of compostable material, for example, is a material that can break down by about 90% within about 6 months on a home or industrial compost heap, and materials that meet this criteria can be marked as “compostable” under European Standard EN 13432 (2000).

Biodegradation tests vary in the specific testing conditions, assessment methods, and criteria desired. As such, there is a reasonable amount of convergence between different protocols leading to similar conclusions for most materials. For aerobic biodegradability, for example, the American Society for Testing and Materials (ASTM) has established ASTM D 5338-92. ASTM D 5338-92 measures the percent of test material that mineralizes as a function of time. The test monitors the amount of carbon dioxide being released as a result of assimilation by microorganisms in the presence of active compost held at a thermophilic temperature of 58° C. Carbon dioxide production testing may be conducted using electrolytic respirometry. Other standard protocols, such 301B from the Organization for Economic Cooperation and Development (OECD), may also be used. In some embodiments, a material is biodegradable if it has degraded by 60% or more in 28 days. See OECD 301D “closed bottle test” (Organization for Economic Cooperation and Development, France). Standard biodegradation tests in the absence of oxygen are described in various protocols such as ASTM D 5511-94. These tests could be used to simulate the biodegradability of materials in an anaerobic solid-waste treatment facility or sanitary landfill.

The Biodegradable Products Institute (BPI) and US Composting Council (USCC) use American Society for Testing and Materials Specifications (ASTM) to approve products for their “Compostable Logo.” These specifications are used to identify plastic and paper products which disintegrate and biodegrade completely and safely when composted in a municipal or commercial facility, like kraft paper, yard trimmings and food scraps. The “Compostable Logo” is awarded to any products meeting ASTM D6400 or D6868, based on testing in approved independent laboratories. The BPI certification, for example, demonstrates that a material meets the specifications in ASTM D6868 and will biodegrade swiftly and safely during municipal, commercial, or household composting.

For example, ASTM has developed test methods and specifications for compostability that measure three characteristics: biodegradability, disintegration, and lack of ecotoxicity. To meet the biodegradability criteria for compostability, the material achieves at least about 60% conversion to carbon dioxide within 40 days and, as a measure of disintegration, less than 10% of the test material remains on a 2 millimeter screen in the actual shape and thickness that would exist in the disposed product. To determine the lack of ecotoxicity, the biodegradation byproducts must not exhibit a negative impact on seed germination and plant growth, which can be measured using the test detailed in OECD 208. See, for example, http://www.oecd.org/dataoecd/11/31/33653757.pdf. The International Biodegradable Products Institute will issue a logo for compostability, for example, once a product is verified to meet ASTM 6400-99 specifications. The protocol follows Germany's DIN 54900 which determines the maximum thickness of any material that allows complete decomposition within one composting cycle.

In some embodiments, the materials can biodegrade completely in less than 60 days, less than 50 days, less than 40 days, less than 30 days, less than 20 days, less than 10 days, or any range therein. In some embodiments, the materials can biodegrade up to 75%, up to 80%, up to 85%, up to 90%, up to 95%, up to 98%, up to 99%, or any range therein, in less than 30 days, less than 28 days, less than 25 days, less than 20 days, or any range therein. In some embodiments, the products produced from the compositions taught herein meet the specifications in ASTM D6868 for biodegradability.

In certain embodiments, the teachings herein are directed to a composition comprising a biodegradable fiber component in an amount ranging from about 5% to about 40% on a dry weight basis, preferably about 15% to about 30%; a starch component in an amount ranging from about 40% to about 94.5% on a dry weight basis, preferably about 45% to about 75%; and one or more additive components in an amount ranging from more than 0% to about 15% on a dry weight basis, preferably about 0.5% to about 10%. In certain embodiments, the additive components may be present in an amount ranging from about 1.5% to about 7% on a dry weight basis. In certain embodiments, the additive components may be present in an amount ranging from about 2% to about 5% on a dry weight basis.

The biodegradable fiber component can comprise a natural fiber, and the natural fiber can comprise a woody fiber, a non-woody fiber, or an animal fiber such as wool. Woody fibers can come from trees, for example, and are the principal source of cellulosic fiber. Non-woody fibers include, but are not limited to, bagasse, bamboo, and straw. Examples of natural fibers can include, but are not limited to wool, cotton, wood pulp fibers, bamboo, kenaf, flax, jute, hemp, abaca, grass, reeds, and the like. The fiber component can also include mixtures of any of the fibers taught herein.

Any biodegradable synthetic fiber known to one of skill may be used in some embodiments of the present invention. Examples of such synthetic fibers can include, but are not limited to, polyolefin, polyester, polyamide, acrylic, rayon, cellulose acetate, poly(lactide), poly(hydroxy alkanoates), thermoplastic multicomponent fibers (such as conventional sheath/core fibers, for example polyethylene sheath/polyester core fibers) and the like and mixtures thereof. In many embodiments, the synthetic fibers will be partially or completely biodegradable as defined in ASTM D 6400.

Several natural fibrous materials may be used in combination both as structural elements (at several size scales) in the baked items and or as inexpensive organic fillers. Fiber elements are used both to control the molding characteristics of the wet batter and to enhance the structural stability of the finished food service and packaging articles. Although there is a continuum of fiber lengths and fiber aspect ratios that can potentially be used in the formulation, the fibrous portion of the formulation can be in a general sense separated into three classes (based on fiber length) that serve different functions: long or very long (4 to 25 mm or longer) fibers or composite fiber elements are used to form a mesh of fibers that can help to prevent defects from forming in the batter as it expands in the mold; medium-length fibers (0.5 to 5 mm) can also help control the flow characteristics of the wet batter and serve to increase the toughness of the finished food service articles, preventing fracture during handling and during normal use; short fibers (<0.5 mm) serve mainly as a way to introduce readily biodegradable material into the formulation. In general, longer fibers have higher aspect ratios than short fibers, since there is generally greater variation in fiber length than fiber diameter. Average aspect ratios for long or very long fibers can range from about 40:1 to more than 1,000:1. Medium-length fibers can have average aspect ratios ranging from about 5:1 to about 200:1. For short fibers, aspect ratios are typically less than about 50:1. Some filler material, for example, can be more water-resistant than the starch-based matrix that contains them. (Several types of fiber provide this functionality, but the presence of the medium, long, and very long fibers are required for the molding, handling and usage characteristics they provide, whereas the short fiber elements may be, in some embodiments, present primarily for their contribution to water-resistance.)

Fibers from several sources can be included in many of the compositions taught herein. Relatively high quality fibers from grass or reed species provide mid-length fibers that can contribute to structural stability and resilience in the finished articles. Long to very long fibers, or fiber composites, may come from lightly processed agricultural byproducts, such as stalk or husk materials that have been chopped, ground, or milled to an appropriate size. Under appropriate processing conditions such as, for example, hammer or knife milling, these materials can provide a considerable amount of the very short fiber that can replace some of the starch in some embodiments, as well as add water resistance to the finished article. In addition, the fibrous material in the form of ground wood, e.g., wood flour; ground cellulose, e.g., ground bamboo pulp; ground nut shells (or other very hard, lignin-rich plant materials); or any combination thereof, may also serve as organic, relatively water resistant, biodegradable filler used to replace conventional inorganic filler materials.

Some fibers can be obtained from fast-growing plants, such as grasses or reeds that include, but are not limited to, kenaf and bamboo. Some fibers are also widely available as a by-product of agricultural production—stalks, stems, and husks from cereal grains, for example, are a ready source of medium length fiber.

The fibrous materials can vary greatly in fiber length and fiber aspect ratio. In some embodiments, the materials can have an average fiber length that is less than about 2 mm and an average aspect ratio that is in the range of about 1.1:1 to 250:1, about 1.3:1 to 125:1, about 1.4:1 to 70:1, or about 1.5:1 to 30:1.

There are several sources available for the starch component. Sources of starch may include, but are not limited to, plant sources such as tubers, roots, seeds, and or fruits of plants, and specific plants sources may include corn, potato, tapioca, rice, or wheat or similar, or animal sources, namely glycogen. In some embodiments, starch is a combination of both pregelatinized and uncooked or native starches. In some embodiments, the pregelatinized starch has a concentration in the range of about 0% to about 30% by weight of total starch in the formulation, or more than 0% to about 30% by weight of total starch in the formulation, and more preferably 3% to 20%, and most preferably 5% to 15%. Food-grade starches (pregelatinized or uncooked) that have been modified by cross-linking, stabilization, or addition of lipophilic functional groups may be included to increase resistance of the products to softening when exposed to aqueous foods.

In some embodiments, the starch can be a water-resistant starch, for example, a modified starch, which may be, for example, a chemically modified starch such as alkenyl succinic anhydride modified starch, acetic anhydride modified starch, vinyl acetate modified starch, acrolein modified starch, epichlorohydrin modified starch, phosphorus oxychloride modified starch, sodium trimetaphosphate modified starch, or propylene oxide modified starch, or the like; an unmodified starch such as high-amylose starch; or a combination thereof; or any other starch known in the art which has water-resistant properties. In some embodiments, the starch component can include a high-amylose starch. For example, the starch component can comprise natural starch, pre-gelatinized starch, high-amylose starch, or a combination thereof. In some embodiments, at least a portion of the starch component can be comprised of one or more water-resistant starches. The water-resistant starches may either be standard starches that have been chemically modified to be water resistant, such as, e.g., alkenyl succinic anhydride modified starch, acetic anhydride modified starch, vinyl acetate modified starch, acrolein modified starch, epichlorohydrin modified starch, phosphorus oxychloride modified starch, sodium trimetaphosphate modified starch, or propylene oxide modified starch, or the like, or high amylose starches that are water resistant in their native, unmodified state; or a combination thereof; or any other starch known in the art which has water-resistant properties. In these embodiments, the water-resistant fraction of the starch component may include chemically modified water-resistant starch, naturally water resistant high-amylose starch, or a combination thereof. Use of water-resistant starches as a portion of the starch component increases the moisture resistance of the finished products.

In some embodiments, the starch component comprises an organic filler material having a ratio of starch to filler that ranges from about 10:1 to about 1:1. In some embodiments, the starch component can include a filler material, most often an organic filler, with the ratio of starch to filler typically having a value of about 3:1.

In many embodiments, the filler is organic. The organic filler material may include, for example, ground nut shells such as walnut shells; ground wood, e.g., wood flour; ground cellulose, e.g., ground bamboo pulp; or any combination thereof. The organic filler material can result in fibrous matter that includes short or very short fibers, and they may be used alone as the filler material or be combined with other filler materials. In some embodiments, the concentration of organic filler material in the compositions is more than 0% to about 30% by dry weight, or about 5% to about 30% by dry weight. The organic filler materials may be used alone as the filler material or in combination with other filler materials. In some embodiments, the concentration of organic filler material can be about 10% to 25%, or about 15% to 21% of the dry weight of the product.

In some embodiments, short fibers may be used in conjunction with, or replaced by other filler materials imparting the same advantages as the shorter fibers. For example, such filler materials may include both organic and inorganic aggregates such as calcium carbonate, silica, calcium sulfate, calcium sulfate hydrate, magnesium silicate, micaceous minerals, clay minerals, titanium dioxide, talc, etc. The concentration of aggregate and/or short fibers may be in a range of about 0% to about 30%, about 2.5% to about 25%, about 5% to about 20%, about 5% to about 25% or about 7% to about 21% of the dry weight of the formulation.

The additive component can add water resistance, strength, or a combination of water resistance and strength to an article of manufacture produced from a biodegradable, starch-based, composition. In some embodiments, the additive component comprises an epoxidized vegetable oil, a hydrogenated triglyceride, poly(vinyl acetate), poly(vinyl acetate-ethylene) copolymer, poly(ethylene-vinyl acetate) copolymer, or a combination thereof. In some embodiments, the additive is present in an amount ranging from about 2% to about 5%.

In certain embodiments, the additive component comprises epoxidized triglycerides. Although traditionally used as plasticizers, particularly for PVC and PVDC (polyvinyl chloride and polyvinylidene dichloride), epoxidized vegetable oils in the starch based composite surprisingly allows for a broader density range of articles of manufacture that can be produced using a heated mold process. Surprisingly, the manufacture of denser articles does not require a longer heating time when epoxidized oils are used. Further, denser articles are stronger and may be more economical to produce than thicker articles, which ordinarily require longer heating times. Epoxidized triglycerides can be obtained by the epoxidation of triglycerides of unsaturated fatty acids from animal or vegetable sources. Examples of suitable epoxidized vegetable oils are epoxidized linseed oil, epoxidized soybean oil, epoxidized corn oil, epoxidized cottonseed oil, epoxidized perilla oil, epoxidized safflower oil, and the like. In some embodiments, the epoxidized vegetable oils can include epoxidized linseed oil (ELO) and epoxidized soybean oil (ESO). To meet FDA requirements for food contact, ELO typically needs an iodine number of less than about 5 and a minimum oxirane oxygen content of about 9%, and ESO will typically have an iodine number of less than about 6 and a minimum oxirane oxygen content of about 6%.

A variety of epoxidized vegetable oils can be used. In some embodiments, the epoxidized vegetable oils have an epoxide equivalent weight of about 400 to about 475. Partially epoxidized vegetable oils may be used in some embodiments. In some embodiments, the epoxidized vegetable oils used in this invention have an epoxide equivalent weight of less than about 225. For example, epoxidized linseed oil having an epoxide equivalent weight of 178 can be reacted with a monocarboxylic acid or a monohydric phenol to raise the equivalent weight to 400-475.

The additive component comprises a hydrogenated triglyceride in some embodiments. Starch-based biodegradable compositions can uses waxes, such as carnauba wax, candelilla wax, paraffin wax, montan wax, polyethylene wax, and the like to increase water resistance. Carnauba wax, for example, is quite expensive and its use is limited to no more than about 3% on a dry wt. basis because it can steam distill out during molding and plug the vents in the molding apparatus used to form an article of manufacture from the composition. In some embodiments, hydrogenated vegetable oil with a melting point of between about 54° C. and 85° C. can be used in place of the wax to improve the moisture resistance of the formulation. Suitable hydrogenated triglycerides can be prepared from animal or vegetable fats and oils such as tallow, lard, peanut oil, soybean oil, canola oil, corn oil and the like. Suitable hydrogenated vegetable oils include those available from EvCo Research under the trade names EVCOPEL EVCORR, and EVCOPEL EVCEAL. In some embodiments, the hydrogenated triglycerides are used in concentrations of up to 5%. The hydrogenated triglyceride can be added to the formulation in the form of a solid powder, melt, or as an emulsion.

The additive component can be a polymer. In some embodiments, the additive component is a polymer selected from the group consisting of poly(vinyl acetate) (PVA), poly(vinyl acetate-ethylene) (VAE) copolymer, and poly(ethylene-vinyl acetate) (EVA) copolymer. When added to the starch based composite, PVA, VAE, and EVA increase the moisture resistance of the compositions. EVA is a copolymer of ethylene and vinyl acetate with less than 50 wt. % vinyl acetate; whereas, VAE is a copolymer of ethylene and vinyl acetate with more than 50 wt. % vinyl acetate. EVA's are typically semi crystalline copolymers with melting points between about 60° C. and 110° C. and glass transition temperatures (T_{g}) similar to polyethylene. VAE's, on the other hand, are typically amorphous polymers (no defined melting point) with T_{g}'s in the range of about −20° C. to about 30° C. To facilitate addition to an aqueous formulation the polymers will preferably used in the form of emulsions or latices.

The composition can be in the form of an aqueous mixture, wherein the mixture contains water in a quantity sufficient to allow for shaping of the composition into a form that creates a biodegradable, disposable, and water-resistant article of manufacture when heated at a sufficient temperature and for a sufficient time. One of skill in the art will appreciate that there are a variety of processes available for shaping an article of manufacture, for example, molding, injection molding, expansion molding, pressing, stamping, and the like, where each of the available processes will vary according the water content, or consistency, of the composition that is needed for such processing. In some embodiments, the aqueous mixture can have from about 40% to about 80% water by weight, from about 45% to about 75% water, from about 50% to about 70% water, from about 55% to about 65% water, or any range therein. Further, one skilled in the art will recognize that, in some embodiments, the mixtures can be water-based, partially water-based, and potentially organic solvent-based. For example, such mixtures could be alcohol-based mixtures or other non-water-based mixtures.

In some embodiments, the starch component of an aqueous mixture can comprise a combination of native starch and pre-gelatinized starch. The ratio of the fiber to pre-gelatinized starch can range, for example, from about 1.5:1 to about 3:1, from about 1:1 to about 4:1, from about 2:1 to about 5:1, or any range therein.

In some embodiments, the aqueous mixture can further comprise magnesium stearate, a wax, a cross-linking agent, or a combination thereof. The magnesium stearate is a mold-release agent that also provides some water resistance. A mold release agent, or abherent, is provided to reduce adhesion between baked parts and the mold system. Other mold-release agents can be used including, but not limited to, metal stearate compounds in general, such as aluminum, magnesium, calcium, potassium, sodium, or zinc stearates; fatty acids, such as oleic acid, linoleic acid, etc.; fats; oils; and any combination thereof.

Any of a variety of waxes may be suitable in some embodiments. Examples of waxes include carnauba, candelilla, rice bran, paraffin, or any other food-grade wax. In some embodiments, vegetable waxes may perform better than animal or mineral waxes. In some embodiments, natural waxes may perform better than synthetic varieties. Wax emulsions can be prepared using emulsifying agents and mechanical agitation. Examples of wax emulsions suitable for use in the present formulation include emulsified carnauba wax and emulsified candelilla wax. Emulsifiers include all of those permitted for food applications including, but not limited to, sorbitan monostearate, polysorbate 60, polysorbate 65, polysorbate 80, sodium and potassium stearate, food-grade gums (e.g., arabinogalactan, carrageenan, furcelleran, xanthan), stearyl monoglyceridyl citrate, succistearin, hydroxylated lecithin, and many other like compounds.

Any of a variety of cross-linking agents can be used to cross-link the starch and fiber in some embodiments. The cross-linking agents include, but are not limited to, methylamine compounds, polyvalent (multivalent) acids, polyvalent acid halogenides, polyvalent acid anhydrides, polyaldehydes, polyepoxides, polyisocyanates, 1,4 butanediol diglycidylether, epichlorohydrin resins, glyoxal, ammonium zirconium carbonate, potassium zirconium carbonate, polyamide-epichlorohydrin resin, polyamine-epichlorohydrin resin, and the like.

Other ingredients that can be included in the composition are proteins and natural compounds, natural rubber latex, and fiber sizing agents. Fiber sizing agents include for example, rosin, rosin esters, rosin soaps, alkylketene dimmers (AKD), and alkenyl succinic anhydrides (ASA). Such other ingredients may include, but are not limited to preparations made from casein, soy protein isolate or concentrate, or similar such preparations. One such preparation can be prepared in the following three steps:

1) cooking a solution of casein or soy protein isolate in water (about 10% by weight) as per usual manufacturer's recommendations (generally, hydrating the protein by soaking, then gradually raising the temperature and pH of the solution to 180° F. and pH=9 to 9.5, then holding the solution at 180° F. for 15 minutes);

2) cooling the preparation to room temperature; and optionally,

3) adding a preservative and blending thoroughly. The preferred concentration of preservative in the preparation is about 0.1% or less, depending on the shelf life required for the protein solution, the concentration of protein required in the final product, and the limits imposed by government regulations on the dosages of preservative compounds in edible materials.

Other proteins may also be used in combination with the casein or soy protein preparation or separately to improve the water-resistant properties of the containers. For example, such proteins may include albumen, gelatin, and the like.

In some embodiments, the invention includes a method of creating a biodegradable, starch-based, water-resistant article of manufacture. The method comprises adding a composition taught herein to a mold apparatus having a cavity. The composition can be an aqueous mixture that is heated in the mold apparatus at a sufficient temperature and for a sufficient time for the mixture to be a stable form having a skin formed on the outer surface of the mixture where the mixture contacts the surface of the cavity during the heating. The mold apparatus comprises at least one gap so that the vapor can exit the cavity of the mold though the gap without substantial loss of the mixture through the gap.

In some embodiments, the invention includes producing an article of manufacture using a composition taught herein, wherein the article of manufacture is biodegradable and water-resistant. One of skill will appreciate that the compositions taught herein can produce materials having an almost endless array of uses. In some embodiments, the products can be used in the food industry. The food industry products can include, but are not limited to, single-compartment and multi-compartment trays, bowls, cold cups, hot cups with lids, plates, baking pans, muffin trays, and restaurant take-out containers with lids. In some embodiments, materials can be used to produce general packaging products, such as for electronic product packaging, battery packaging, and the like. In many embodiments, the materials can be used to produce products that can be filled, frozen, shipped, baked, microwaved, served, and even consumed. In some embodiments, the products are fully microwavable, ovenable, insulating, and/or are harmless if eaten. In some embodiments, the products can be scented and flavored. In some embodiments, the article of manufacture is compostable. In some embodiments, the article of manufacture is an approved food product that is edible.

In some embodiments, the invention includes a method of creating a biodegradable, starch-based, water-resistant article of manufacture. The method comprises preparing a mixture of a biodegradable fiber component and a starch component. The biodegradable fiber component is in an amount ranging from about 5% to about 40% on a dry weight basis, and the starch component is in an amount ranging from about 40% to about 94.5% on a dry weight basis. An additive component is added to the mixture in an amount ranging from about 0.5% to about 10% on a dry weight basis. The additive component can comprise a hydrogenated triglyceride, poly(vinyl acetate), poly(vinyl acetate-ethylene) copolymer, poly(ethylene-vinyl acetate) copolymer, or any combination thereof. An aqueous component is added to the mixture to create an aqueous composition, wherein the aqueous component comprises water in a quantity sufficient to allow for shaping of the composition into a desired form.

Other additives can be added as part of the aqueous component, such as salts, buffers, coloring agents, vitamins, nutrients, pharmaceuticals, nutraceuticals, organic filler materials, and the like. The desired form is then heated at a sufficient temperature and for a sufficient time to create a biodegradable, disposable, and water-resistant article of manufacture from the composition.

In some embodiments, the invention includes a method of creating a biodegradable, starch-based, water-resistant article of manufacture having an improved strength. The method comprises preparing a mixture comprising a biodegradable fiber component and a starch component, wherein the biodegradable fiber component is in an amount ranging from about 5% to about 40% on a dry weight basis, and the starch component is in an amount ranging from about 40% to about 94.5% on a dry weight basis. An additive component is added to the mixture in an amount ranging from about 0.5% to about 10% on a dry weight basis. The additive component comprises an epoxidized triglyceride, poly(vinyl acetate), poly(vinyl acetate-ethylene) copolymer, poly(ethylene-vinyl acetate) copolymer, or a combination thereof. An aqueous component is added to the mixture to create an aqueous composition, wherein the aqueous component comprises water in a quantity sufficient to allow for shaping of the composition into a desired form. The desired form is heated at a sufficient temperature and for a sufficient time to create a biodegradable, disposable, and water-resistant article of manufacture from the composition.

### EXAMPLE 1

### Preparing a Composition

Table 1 provides components and compositions ranges that are useful in some embodiments of the present invention.

TABLE 1

| | Range | Preferred Range |
|---|---|---|
| Material | (Wt. % wet basis) | (Wt. % wet basis) |
| Water | 40-80 | 55-65 |
| Fiber | 2-16* | 6-12* |
| Filler | 2-16* | 4-12* |
| Native starch | 8-30* | 14-25* |
| Pre-gel starch | 1-10* | 2-6* |
| Magnesium stearate | 0-4* | 0.4-2* |
| Wax | 0-3* | 0.4-1.2* |
| Crosslinker | 0-2* | 0.2-0.6* |
| Epoxidized veg. oil | 0-3.2* | 0.2-2.4* |
| PVAc, VAE etc. | 0-4* | 0.8-2.5* |

*Note:
Divide by 0.4 to get the value for dry weight basis

At least one of the materials, magnesium stearate, epoxidized vegetable oil, or wax (including hydrogenated triglyceride), should be used, and, in some embodiments, that amount used is in the range of about 1.0-3.5 percent on a wet weight basis. In some embodiments, the ratio of total starch to filler should be about 3:1. The ratio of fiber to pre-gelatinized starch ranges from about 1.5:1 to 3:1 and, in some embodiments, is about 1.9:1 to 2.5:1. Optional ingredients include protein, natural rubber latex, coloring agents, and fiber sizing agents.

### EXAMPLE 2

### Preparing a Article from the Composition

Articles were produced from the aqueous composition using a vented, heated mold apparatus. Many types of batch and continuous internal mixers, such as planetary mixers, dual arm sigma type mixers, and extruders, are suitable to prepare the formulation. In some embodiments, the mixture can be prepared in a relatively low shear mixer such as a planetary mixer at ambient temperature.

To prepare the formulation, fiber (typically cut into strips from sheet stock) and about 40% of the total filler were taken with about 30-40% of the total water in a planetary mixer and mixed for about 5 minutes to the consistency of coarse eraser crumbs. The pre-gel starch was added and mixing was continued for about 6-9 minutes to further disaggregate the fiber. The remaining ingredients were added to the mixer and mixed for about 2-3 minutes until the mixture appeared to be free of dry lumps. The required mixing time will vary with scale and speed of mixing.

To form an article, a heated mold apparatus having a cavity in the shape of a desired final product was used to form small trays. In this process, the mold apparatus has gap or gaps for venting vapor produced during heating or baking. A mixture that is liquid or semi-liquid is added to the cavity of the mold apparatus, the apparatus is closed, and vapor or steam is produced within the mixture during as it heats. In this embodiment, the volume of mix introduced into the mold cavity is substantially less than the cavity volume, but the mixture expands with the development of internal vapor or steam pressure during heating until it completely fills the cavity. In this embodiment, the ratio of the volume of liquid or semi-liquid material that is put into the mold to the volume of the mold cavity is between 1:4 and 1:2.5, or, alternatively, between 1:3.7 and 1:3.1. Upon sufficient contact of the mixture to the heated mold apparatus, a skin forms on the outer surface of the mixture. The skin is permeable or semi-permeable to the vapor or steam and the combination of the skin and the gap allows escape of steam or vapor from the cavity to the exterior of the mold apparatus. The escape of steam or vapor is accomplished without the escape of any significant amount of the mixture. A significant amount of escape of the mixture would result in a waste of raw materials, and a waste of energy needed to heat the additional escaping materials, as well as require additional processes to remove excess material and any material clogging the vent gaps

The vapor escapes while the mixture is retained in the cavity because the gap is of sufficient size, for example, small enough that the skin formed on the surface of the mixture from contact of the mixture with the heated mold surface, when under sufficient pressure from the steam or vapor produced during heating the mixture, allows the steam or vapor to escape through the skin and the gap to the exterior of the mold apparatus without rupturing the skin. Because the skin is not permeable to the mixture, which may still be liquid or semi-liquid prior to the completion of heating, the mixture cannot escape from the cavity of the mold apparatus.

The heating or baking temperature and time will vary depending upon the specific mixture and can be readily selected with little experimentation by one skilled in the art. An example of a mold that can be used in this example is taught in U.S. Published Application No. 20040265453, which is hereby incorporated herein by reference in its entirety.

A typical mold temperature will be in the range of 160-240° C. and, in some embodiments, in the range of about 180-220° C. The heating or bake time depends greatly on the size and thickness of the article and typical articles range from about 40 seconds to 450 seconds, from about 40 seconds to about 80 seconds, from about 50 seconds to about 300 seconds, from about 60 seconds to about 250 seconds, from about 70 seconds to about 150 seconds, or any range therein. In some embodiments, the material has to be baked down to very low water content (probably less than about 2%) before opening the mold—otherwise the article will burst. In some embodiments, additives that increase the strength of the material allow for shorter minimum bake times because the inherently stronger material can tolerate more internal steam pressure.

### EXAMPLE 3

### Articles are Biodegradable and Compostable

The biodegradation and compostability was tested on a sample of articles produced using the biodegradable, starch-based, compositions described in this application. These samples did not contain PVA, VAE, EVA, epoxidized vegetable oil, or hydrogenated triglycerides, as taught in some embodiments, but one of skill will appreciate that these additives will not affect the biodegradability or compostability of the compositions. Concentrations for all components were within the ranges described in Table 1, above, except that 0.5% of the mixture consisted of a set of additives not listed in Table 1. (About 90% of this additive set consisted of natural materials—proteins and other natural polymers—that are considered intrinsically biodegradable due to their origin. One of skill in the art will recognize that addition of trace amounts of natural materials to a composition such as that described in Table 1 will not materially affect the measured biodegradability or compostability of that composition.)

The compositions were exposed to Aerobic Composting (Biodegradation) per ASTM D-5338 @ 58±3° C. through contact with compost medium. The results were compared to the biodegradation rate of a positive control of cellulose.

Sample Identification:

A. 9P006-U (Avg)

C. Positive Cellulose Control (Avg)

The Aerobic Biodegradation per ASTM D 5338 @ 58±3° C. of the test samples yielded the following based on (%) carbon conversion in Table 2:

TABLE 2

| | | Carbon Conversion (%) |
|---|---|---|
| Sample: | Description: | Based on CO₂ Production |
| A | 9P006 - U (Avg) | 79.26 |
| C | Positive cellulose control (Avg.) | 98.37 |

The % weight loss was as follows in Table 3:

TABLE 3

| Sample: | Description: | % Weight Loss |
|---|---|---|
| A | 9P006 - U (Avg) | 100.00 |
| C | Positive cellulose control (Avg.) | 100.00 |

Based on the overall weight loss and carbon conversion of the samples and the cellulose control tested per ASTM D 5338 and D 6400, Sample A would be considered to be compostable.

The evaluation of the samples was run per ASTM D-5338 at 58±3° C. per the Tier Two Level testing per ASTM D 6400. Samples ranging in weight from 0.6000-0.6300 grams were placed into 150 grams of composting material. The composting medium had a Carbon:Nitrogen ratio of 31:1 which was within the specifications for this test. Samples had degraded into compost after 65 days and could not be distinguished from or detected in the compost biomass material. The difference in the weight loss data and the carbon dioxide generation for the-samples indicates that physical disintegration occurred as the material composted.

The cellulose control had total degradation. The carbon conversion (%) for the cellulose was normal for this test and also confirmed a viable, active compost mixture. The amount of carbon from sample A converted to CO₂ during the test was for 79.26% of the total carbon present in the sample.

The efficiency of CO₂ produced compared to the maximum theoretically calculated CO₂ which should have been produced was 79.26% for sample A since all of the sample had degraded.

Based on the overall weight loss and carbon conversion, these materials would be considered to have excellent compostability/biodegradability. Per ASTM D 5338 and D 6400 fully compostable materials need to exceed 60% weight loss during the test (which the samples did achieve) and have a total carbon available converted to CO₂ percentage greater than 60% (which the samples did achieve) to be considered totally compostable materials.

In the examples set forth below, the one or more additive components in the samples may be present in an amount ranging from more than 0% to about 15%. In certain embodiments of the samples, the additive components may be present in an amount ranging from about 0.5% to about 10%. In certain embodiments of the samples, the additive components may be present in an amount ranging from about 1.5% to about 7%. In certain embodiments of the samples, the additive components may be present in an amount ranging from about 2% to about 5%. Specific samples, including amounts of the additive components falling with the above described ranges, are shown below. Unless otherwise indicated, all percent amounts for the various components shown below refer to the percent on a dry weight basis.

### EXAMPLE 4

### Additives Improve the Density and Water Resistance of Articles

Several additives have been found that improve the toughness of the formulation and improve the moisture resistance. The addition of poly(vinyl acetate) (PVAc) and/or poly(vinyl acetate-ethylene) (VAE) emulsions to the biodegradable, starch-based compositions improves the moisture resistance of the formulation, as measured by the Cobb value (g/m2). The Cobb value is a standard paper industry test method (ASTM D 3285) to determine the moisture resistance of sized paper and paperboard. The test method involves determined the quantity of water absorbed (weight gain of the sample in gm) by a fixed surface area (m2), in a specific time. Standard conditions employ a metal ring with an internal diameter of 11.28 cm (cross-sectional or surface area of 100 cm2) clamped onto the sample to contain 100 ml of water and a water contact time of 2 minutes. After contact, the water is drained from the metal ring and excess water is blotted from the sample with blotting paper. To control the amount of blotting, a 10 kg metal roller is rolled twice over the blotting paper, which is on top of the sample. Variations possible with the method include using different diameter rings for smaller samples (25 or 10 cm² surface area, with a corresponding reduction in the amount of water employed), use of shorter (1 minute) or longer (18 hours) contact times, and use of other test liquids. Conditioning of the samples and blotting paper to 50% RH at 23° C. (ASTM D685) is utilized for the Cobb test. Besides moisture resistance, the PVAc and VAE additives have also been found to maintain or improve other important physical properties, such as tensile strength, modulus and impact.

It has also been found that the addition of epoxidized vegetable oil, such as epoxidized linseed oil (ELO) and epoxidized soybean oil (ESO), to the biodegradable, starch-based compositions allows for a broader density range of articles to be manufactured in the heated mold described above. Surprisingly, the manufacture of denser articles does not require a longer bake time when epoxidized oils are used. Denser articles are stronger and may be more economical to produce than thicker articles, which require longer bake times.

Table 4 shows that with a composition comprising 15% bamboo fiber, a given tray mold with a volume of 59.8 cc showed a maximum fill weight of 36 g of batter (at 40% solids) and had a minimum bake time of 65 seconds. The 15% “standard” fiber samples in Table 4 also contained 4% magnesium stearate (MgSt) and 2% carnauba wax unless otherwise noted. The 29% “high” fiber samples in Table 4 contained 3.5% MgSt and 3% carnauba wax. All samples were molded at a nominal thickness of 80 mil unless otherwise indicated.

TABLE 4

| | Max. | Min. | | |
|---|---|---|---|---|
| | Fill | Bake | Production | Cobb |
| | weight | Time | fill weight | Value^{†} |
| Sample | (g) | (sec) | (g) | (g/m²) |
| 141030 15% Fiber control | 36 | 65 | 34 | 65.6 |
| 141032 Std. fiber + 5% PVAc1 | 36 | 60 | 34 | 56.7 |
| 141051 Std. fiber + 2% ELO1 | 42 | 65 | 34 | 67.9 |
| 141159 Std. fiber + 3% MgSt + | 40 | 73 | 39 | 70.7 |
| 1.5% ELO1 | | | | |
| 141172 Std. fiber + 3% MgSt + | 50 | 145 | 48 | 70.7 |
| 1.5 ELO1 at 105 mils thick | | | | |
| 141102 29% Fiber control | 48 | 68 | 46 | 54.7 |
| 141069 High fiber + 5% PVAc2 | 48 | 65 | 44 | 46.7 |
| 141074 High fiber + 5% VAE5 | 49 | 70 | 48 | 49.3 |
| 141098 High fiber + 5% PVAc2 + | 50 | 73 | 48 | 62.7 |
| 2% ELO1 | | | | |
| 141100 High fiber + 5% PVAc2 + | 54 | 65 | 48 | 50.7 |
| 2% ESO1 | | | | |
| 141096 High fiber + 5% PVAc1 + | 55 | 65 | 48 | 50.7 |
| 2% Corn Oil | | | | |
| 141081 High Fiber + 5% VAE5 + | 54 | 65 | 48 | 50.7 |
| 2% ELO1 | | | | |

^{†}Cobb Value measured after 2 minutes
Legend:

| | | | |
|---|---|---|---|
| Code | Composition | Trade name | Supplier |
| PVAc1 | Poly(vinyl acetate) | Vinac 21 | Air Products |
| ESO1 | Epoxidized soybean oil | BioFlex ESBO | Blackman |
| | | | Uhler |
| | | | Chemical |
| ELO1 | Epoxidized linseed oil | BioFlex ELO | Blackman |
| | | | Uhler |
| | | | Chemical |
| VAE5 | Poly(vinyl acetate- | Airflex 100HS | Air Products |
| | ethylene) | | |
| PVAc2 | Poly(vinyl acetate) | Vinac 828M | Air Products |
| VAE7 | Poly(vinyl acetate- | Airflex 1082 | Air Products |
| | ethylene) | | |
| Corn Oil | Corn oil | | Mazola |

For example, the data shows that the addition of 5% of PVAc1 to the 15% Fiber control composition results in a shorter bake time and significantly less water uptake (lower Cobb value). The addition of 2% ELO1 allows for significantly denser articles to be manufactured (42 vs. 36 g maximum mold fill) without increasing the bake time. Reducing the MgSt content from 4 to 3% reduces the density or maximum fill and increases the bake time and Cobb value. Increasing the mold thickness allows more material to be added to the mold (maximum fill and production weight) but significantly increases bake time and does not help water resistance.

Increasing the fiber content from 15% to 29% results in denser articles. The further addition of PVAc or VAE improves the moisture resistance. The addition of ELO or ESO also increases the density of articles that can be manufactured. The addition of corn oil also allows for denser articles to be made, but significant quantities of oil were observed blowing out of the steam vents in the mold. This would ultimately lead to clogging and down time in manufacturing to clean the molds. Clearly, the epoxidized oils are more compatible with the starch matrix.

These additives improve the moisture resistance of the compositions, allow higher density parts to be manufactured, and do not increase the bake time. These improvements to the moisture resistance and physical properties (via increased part density) are made without adversely affecting the manufacturing cycle time or compromising the biodegradability of the products.

### EXAMPLE 5

### Additives Improve the Moisture Resistance of Articles

Several additives have been found that improve the moisture resistance of the compositions. Waxes can be used to improve the moisture resistance and aid in mold release. The wax used is preferably biodegradable, compostable, and natural. Carnauba wax, for example, works well but is quite expensive, and its use is limited to no more than about 3% because it steam distills out, plugging the mold vents. It was found that hydrogenated vegetable oils having a melting point between about 54° C. and 85° C. can be used in place of carnauba wax and improve the moisture resistance of the formulation as measured by Cobb value. Suitable hydrogenated vegetable oils are available from EvCo Research under the trade names EvCopel EvCorr and EvCopel EvCeal. Further, at levels of up to 3% on a dry weight basis essentially no material builds up in the mold vents of a molding apparatus. The hydrogenated vegetable oil can be dispersed in the formulation in the form of powder, incorporated as a melt (with or without surfactants) or preferably as an emulsion.

A composition with 15% bamboo fiber, 4% MgSt, and 2% carnauba wax has a 2-minute Cobb value of around 65-66 g/m² as shown in Table 5. Carnauba wax and MgSt are expensive components so it is desirable to limit their use. However, when the MgSt content is lowered to 3%, with 2% carnauba wax still in the formulation, the 2-minute Cobb value increases to about 70-71 g/m². A 15% bamboo fiber sample with no MgSt and 3% carnauba wax had a 2-minute Cobb value of 88 g/m². A 15% bamboo fiber sample with no MgSt and 3% hydrogenated castor oil (no carnauba wax) had a 2-minute Cobb value of about 94-95 g/m².

TABLE 5

| | Max. | Min. | | |
|---|---|---|---|---|
| | Fill | Bake | Production | Cobb |
| | weight | Time | fill weight | Value |
| Sample | (g) | (sec) | (g) | (g/m²) |
| 141030 15% Fiber, 4% MgSt, | 36 | 65 | 34 | 65.6 |
| 2% Carnauba - control | | | | |
| 141159 15% Fiber, 3% MgSt + | 40 | 73 | 39 | 70.7 |
| 1.5% ELO1 | | | | |
| 141120 15% Fiber, 0% MgSt + | 45 | 63 | 44 | 88.0 |
| 1.5% ESO1 + 3% carnauba wax | | | | |
| 141139 15% Fiber, 0% MgSt + | 36 | 58 | 36 | 94.7 |
| 3% Cast + 1.5% ELO1 | | | | |
| 141174 15% Fiber, 3% MgSt + | 40 | 73 | 38 | 65.3 |
| 1.5% ELO1 + 2% EvCo1 | | | | |
| 141178 15% Fiber, 3% MgSt + | 36 | 65 | 35 | 58.7 |
| 2% EvCo1 | | | | |
| 141182 15% Fiber, 3% MgSt + | 37 | 68 | 36 | 57.3 |
| 2% Emul01 | | | | |
| 141187 15% Fiber, 3% MgSt + | 38 | 70 | 37 | 60.0 |
| 2% Emul02 | | | | |
| 141192 29% Fiber, 3.5% MgSt + | 44 | 63 | 42 | 48.0 |
| 2% Emul03 | | | | |
| 141197 29% Fiber, 3.5% MgSt + | 44 | 73 | 43 | 44.0 |
| 3% Emul04 | | | | |
| 150803 15% Fiber, 3% MgSt + | 41 | 73 | 40 | 57.3 |
| 3% Emul05 | | | | |
| 150805 29% Fiber, 3.5% MgSt + | 43 | 60 | 40 | 41.3 |
| 5% PVAc2 + 3% Emul05 | | | | |

Legend: (See also Legend in Example 4)

| | | | |
|---|---|---|---|
| Code | Composition | Trade name | Supplier |
| Cast | Hydrogenated Castor oil | Castor Wax MP80 | Vertellus |
| EvCo1 | Hydrogenated veg. oil | EvCopel EvCeal | EvCo |
| | | | Research |
| | | | LLC |
| Emul01 | Emulsion of | Emulsion of EvCopel | EvCo |
| | Hydrogenated veg. oil | EvCeal | Research |
| | | | LLC |
| Emul02 | Emulsion of | Emulsion of EvCopel | EvCo |
| | Hydrogenated veg. oil | EvCorr | Research |
| | | | LLC |
| Emul03 | Lower solids emulsion | Emulsion of EvCopel | EvCo |
| | of Hydrogenated veg. | EvCorr | Research |
| | oil | | LLC |
| Emul04 | Emulsion of | Emulsion of EvCopel | EvCo |
| | Hydrogenated veg. oil | EvCeal | Research |
| | | | LLC |
| Emul05 | Emulsion of | Emulsion of EvCopel | EvCo |
| | Hydrogenated veg. Oil | EvCeal | Research |
| | With ELO1 | And | LLC And |
| | | BioFlex ELO | Blackman |
| | | | Uhler |
| | | | Chemical |

The remaining data in Table 5 show that replacing carnauba wax with EvCorr or EvCeal results in significantly less water uptake (lower Cobb value) even at lower levels of MgSt. Further improvements are seen utilizing the hydrogenated vegetable oils as emulsions having some dependence on the surfactant and solids content of the emulsion. Utilizing the oils as emulsions allows for the easy incorporation of additional hydrophobic ingredients, such as the epoxidized vegetable oils, rosin, etc. Addition of PVAc or VAE further improves the moisture resistance, and the moisture resistance is improved while maintaining or improving other physical properties. Moreover, these additives improve the moisture resistance without adversely affecting the bake time, or manufacturing cycle time, or compromising the biodegradability. They are significantly more economical to use than carnauba wax and appear to cause much less fouling of the mold vents in a molding apparatus.

### EXAMPLE 6

### Additives Improve the Strength of Articles

Flexural modulus was determined using a 3-point bend test on a DMA instrument. Essentially the specimen is supported at either end and pressed in the center with a load cell. Force versus displacement is monitored until the test specimen breaks. The rate is slow, unlike an impact test. The method is detailed in ASTM references D 790, D 5023 and D 5934. The 3-point bend data can be used to calculate how much energy or work is required to break the test specimen using the following equation:

Force (at break)×Displacement (at break)=Work (or Energy to break).

Test specimens were equilibrated to 0%, 20%, 50%, or 80% RH for at least 24 hrs. prior to the 3-point bend testing as indicated.

High speed impact testing was done using a Dynatup instrument which has a falling “tup” with a hemispherical tip. This test method can be found in ASTM D 3763. The tup speed in these tests was about 12 ft./sec. Tensile and elongation were measured on an Instron materials testing machine. High speed impact testing, tensile and elongation were determined on samples equilibrated to 50% RH.

TABLE 6

| | 3-point bend | | | Dynatup Impact Data | | |
|---|---|---|---|---|---|---|
| | Flexural | T&E | | | Max | Total |
| | Modulus @ | Tensile | Elongation | Max Load | Deflection | Energy |
| Sample | Yield (Mpa) | (PSI) | (%) | (lb.) | (in.) | (ft · lbf) |
| 141030 | 703 | 265 | 1.2 | 7.15 | 0.211 | 0.159 |
| 15% fiber Control | | | | | | |
| 141032 | 626 | — | — | — | — | — |
| 15% fiber + | | | | | | |
| 5% PVAc1 | | | | | | |
| 141102 | 883 | 597 | 1.8 | 12.69 | 0.252 | 0.309 |
| 29% fiber Control | | | | | | |
| 141028 | 1273 | 489 | 1.5 | 11.96 | 0.197 | 0.238 |
| 29% fiber + | | | | | | |
| 5% PVAc1 | | | | | | |
| 141069 | 1121 | 570 | 1.6 | 12.52 | 0.209 | 0.282 |
| 29% fiber + | | | | | | |
| 5% PVAc2 | | | | | | |
| 141047 | 1168 | 564 | 1.5 | 14.04 | 0.214 | 0.292 |
| 29% fiber + | | | | | | |
| 5% PVAc1 + | | | | | | |
| 1.1% ELO1 | | | | | | |
| 141049 | 1058 | 571 | 1.7 | 13.8 | 0.219 | 0.319 |
| 29% fiber + | | | | | | |
| 5% PVAc1 + | | | | | | |
| 2.0% ELO1 | | | | | | |
| 141074 | 870 | 646 | 1.9 | 13.19 | 0.214 | 0.296 |
| 29% fiber + | | | | | | |
| 5% VAE5 | | | | | | |
| 141076 | 1151 | 533 | 1.8 | 12.98 | 0.181 | 0.263 |
| 29% fiber + | | | | | | |
| 5% VAE7 | | | | | | |

The data in Table 6 is physical property data taken at 50% RH and shows that at 29% fiber, PVAc and VAE improve the high speed impact properties and increase the modulus with little affect on the tensile or elongation. The data also shows that the addition of ELO1 provides some further increase in the impact strength.

TABLE 7

| | Energy to Break (mJ) | | |
|---|---|---|---|
| Sample | 20% RH | 50% RH | 80% RH |
| 141030 15% Fiber Control | 27.3 | 50.2 | 50.1 |
| 141159 15% Fiber + | 56.8 | 49.0 | 46.4 |
| 1.5% ELO1 | | | |
| 141089 15% fiber + | 26.7 | 42.5 | 51.7 |
| PVAc2 | | | |
| 141102 29% fiber control | 73.6 | 83.4 | 130.0 |
| 141069 29% Fiber + | 65.4 | 70.8 | 93.1 |
| 5% PVAc2 | | | |
| 141044 29% Fiber + | 70.5 | 64.0 | 116.8 |
| VAE2 | | | |
| 141074 29% Fiber + | 68.4 | 74.1 | 118.1 |
| 5% VAE5 | | | |
| 141076 29% Fiber + | 62.9 | 69.0 | 119.6 |
| 5% VAE7 | | | |
| 141100 29% fiber + | 69.1 | 63.1 | 93.0 |
| 5% PVAc2 + 2% ESO1 | | | |
| 141098 29% fiber + | 64.5 | 66.9 | 88.9 |
| 5% PVAc2 + 2% ELO1 | | | |

Table 7 describes the “energy to break” at various RH. The data in Table 7 show that the addition of ELO to the 15% fiber formulation significantly increases the energy required to break the material. PVAc and VAE, which improve the moisture resistance, do not negatively impact the energy to break.

TABLE 8

| | | | Energy to |
|---|---|---|---|
| | Modulus @ | Modulus | break |
| Sample | Yield | @ Break | (mJ) |
| 141159 15% fiber + | 725 | 676 | 10.66 |
| 1.5% ELO1 | | | |
| 141182 15% fiber + | 512 | 403 | 7.1 |
| 2% Emul01 | | | |
| 141069 29% fiber + | 1256 | 951 | 21.07 |
| 5% PVAc2 | | | |
| 141197 29% fiber + | 1421 | 717 | 13.1 |
| 3% Emul04 | | | |

Table 8 shows the energy to break for trays after additional baking. The data in Table 8 are for trays that were baked at 193° C. for 40 minutes and then stored in a desiccator to determine which formulations were the least brittle in a bakery application. With the 15% fiber formulation it can be seen that ELO increases the energy to break and would be less brittle. With the 29% fiber formulation it can be seen that PVAc increases the energy at break indicating that these formulations would be less brittle in a bakery application.

In certain embodiments, the above formulations may be used to create edible non-human animal or pet food containers and packaging. The edible non-human animal container is of a shape that is attractive to a non-human animal and preferably includes a flavoring agent that is attractive to a non-human animal or pet. In said embodiment beneficial additives may also be used to enhance flavoring, scents, and nutritional benefits, including: proteins or other nutrients to help balance the packaging content and tune it to the stages of a dog's life; additives such as garlic and similar items that help to ward off pests such as ticks and mites for dogs that ingest them; scents such as chicken, liver, or fish scents that will be attractive to dogs; flavorings such as chicken, gravy, liver, fish, or even rancid fats which are very attractive to pets; and nutritious vitamins that can withstand the product manufacturing phase.

Using the above formulations which result in articles having improved strength of our materials, edibility, ovenability, and microwavability, one may add moist foods to the container, dry food, or even unbaked foods that are either deposited or extruded into the container then sent through an oven to be baked. For moist foods, one may add edible barrier coatings to protect the package. The individual serving dish would then be plastic wrapped for cleanliness and longevity issues and placed into an outer cardboard multi pack system. Because of the strength and durability of the container, a consumer could either add hot water to reconstitute the food or add tap water then microwave the container and food together.

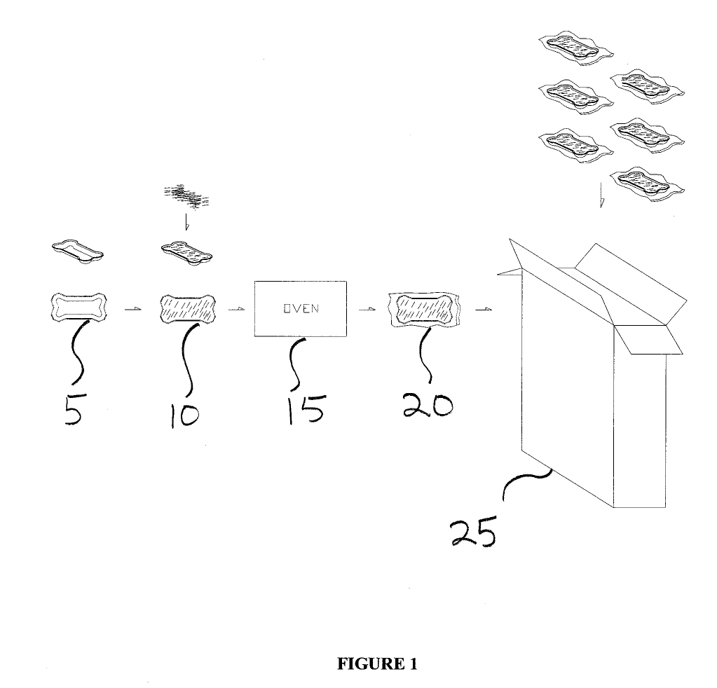

The present embodiments allows food manufacturers great flexibility in preparing and packaging the pet food. For example, individual meal servings (i.e. cook product right in the dish then place into a plastic bag, thus sterilizing and sealing directly) may be provided thus reducing packaging materials by making the outer dish edible, and eliminating any contamination issues whereby pet owners have to wash the dog dish in areas used to wash human dishes. The pet can consume both the food and the outer dish. Referring to FIG. 1, an overview of the packaging of single serving of pet food is shown. In step one, a container is provided according to the above embodiments (5); in step two, cooked or uncooked pet food is added to the container (10); optionally in step three, the container with pet food is cooked or further processed (15); in step four, the processed container and pet food is packaged (20); and in step five, multiple packaged and processed containers and pet food are packaged for sale to a consumer (25).

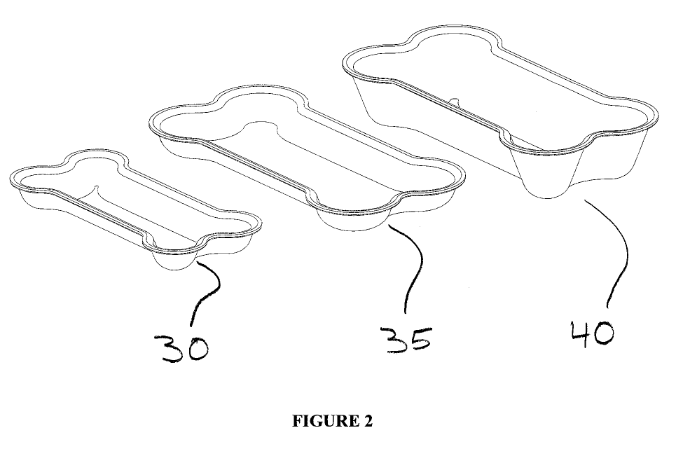

It has been found that for example, dogs prefer bone shaped containers. As such the container may be of any shape, including bone shaped, depending on the specific pet and application. The containers may be provided in several sizes of single serving dishes for small to large pets. Referring to FIG. 2, three sizes are shown: ½ cup (30), 1 cup (35), and 2 cup (40).

In another embodiment, containers fashioned from a mix formulation according to the present invention can be of varying shape and thickness depending upon the desired use for, and properties of, the final container. For example, the containers may be fashioned into open containers such as trays, cones, pie plates, cups, or bowls, or any other useful configuration known in the art.

Further, the thickness of any portion of the container will preferably vary in the range from about 0.5 mm to about 3.2 mm, and more preferably from about 1.5 mm to about 3.0 mm, and most preferably from about 1.6 mm to about 2.5 mm. The thickness of the containers may also vary across the cross-section of the container.

In another embodiment of the present invention a biodegradable material such as an edible coating and or sealant may be applied to containers fashioned from the mix formulation. Said biodegradable material may be applied such that it permeates the inner and/or outer surfaces of the container, thereby improving water and heat resistant properties of the container. Said materials when applied as a coating, may partially or completely permeate the container matrix or a combination of a forming a coating and partially or completely permeating the container matrix.

A further embodiment of the invention is a method to produce a container or other article for use with food or beverage containers. Said method comprises providing the mix formulation set forth above; heating said mix in a mold of desired shape to form a container of a corresponding desired shape. Said method may further comprise steps set forth in U.S. patent application Ser. No. 10/608,441, filed Jun. 27, 2003, which, by reference, is incorporated herein in its entirety.

A further method according to a certain embodiment comprises the steps of providing a mold apparatus having a cavity in the shape of a desired final product and a gap or gaps for venting vapor from the mold apparatus produced during heating or baking, heating or baking the mold apparatus, adding a mixture that is liquid or semi-liquid to the cavity of the mold apparatus prior to closing the mold apparatus and closing the mold apparatus, wherein as vapor or steam is produced in the cavity during heating or baking, the mixture is pushed by vapor or steam pressure to completely fill the cavity, and upon sufficient contact of the mixture to the heated mold apparatus a skin forms on the outer surface of the mixture, the skin being permeable or semi-permeable to the vapor or steam and the skin and gap being such that, in combination, they allow escape of steam or vapor from the cavity to the exterior of the mold apparatus but do not allow any significant amount of the mixture to escape. “Any significant amount of mixture” as referred to herein is any amount the loss of which would cause any one of the drawbacks found in the prior art in a meaningful amount, such as waste of raw materials, waste of energy needed to heat additional mixture, additional processes to remove excess material to form the final product and clogging of the gap or gaps.

The vapor escapes while the mixture is retained in the cavity because the gap is of sufficiently small size that the skin formed on the surface of the mixture from contact of the mixture with the heated mold surface, when under sufficient pressure from the steam or vapor produced during heating or baking of the mixture, allows the steam or vapor to escape through the skin and then through the gap to the exterior of the mold apparatus without rupture of the skin. Because the skin is not permeable to the mixture, which may still be liquid or semi-liquid prior to the completion of heating or baking, the mixture cannot escape from the cavity of the mold apparatus.

The aforementioned method allows for venting of the vapors produced during baking without significant loss of mixture and the associated drawbacks of said loss outlined above such as waste of raw materials, waste of energy needed to heat additional mixture, additional processes to remove excess material to form the final product and clogging of the gap or gaps.

The aforementioned method may be used to manufacture both edible baked goods and other baked products such as starch-based materials for use as food containers and the like. Mixtures for use in said method are typically water-based and include mixtures as described herein. One skilled in the art, however, will recognize that the mixtures need not be water-based, such as alcohol-based mixtures or other non-water-based mixtures. Specific examples of mixtures that may be used said method should be readily apparent to one skilled in the art and include, but are not limited to, common baking mixtures such as waffle, cookie dough, or ice cream cone batter, starch-based mixtures comprised of starch and water and mixtures comprising composite materials mixed with resins that form skins which are still permeable to the gases produced during heating or baking. Further, specific baking procedures such as heating temperature and time will vary depending upon the specific mixture to be heated or baked and should be apparent to one skilled in the art.

Although the invention has been described with respect to specific embodiments and examples, it will be readily appreciated by those skilled in the art that modifications and adaptations of the invention are possible without deviation from the spirit and scope of the invention. Accordingly, the scope of the present invention is limited only by the following claims.

What is claimed is:

1. An edible non-human animal food container comprising
water;
starch, wherein the starch comprises pregelatinized and native starch and wherein the pregelatinized starch is in a range from more than 0% to less than 30% by weight of the total starch in the container;
fibers, wherein a dispersion of the container is such that the fibers are substantially separated from one another throughout a starch based matrix;
wherein the edible non-human animal container is of a shape that is attractive to a non-human animal and further comprises a flavoring agent that is attractive to a non-human animal.

2. The container claim 1 wherein the pregelatinized starch is in a range from more than 5% to less than 20% by weight of the total starch in the container.

3. The container of claim 1 further comprising an insolubilizing compound and wherein the insolubilizing compound comprises an aqueous solution containing modified ethandial, glyoxal-based reagents, ammonium zirconium carbonate, potassium zirconium carbonate or polyamide-epichlorohydrin compounds.

4. The container of claim 3 wherein the insolubilizing compound is in a concentration in a range from about 0.1% to about 20% by weight of the total starch in the container.

5. The container of claim 1 further comprising a casein, latex, or soy protein.

6. The container of claim 5 wherein the ratio of latex solids to casein solids is in a range between about 1 to 1 and about 2 to 1.

7. The container of claim 1 wherein the fibers comprise long fibers having a length of more than 4 mm, medium fibers having a length of 0.05 to 4 mm, and short fibers having a length of less than 0.5 mm.

8. The container of claim 1 wherein the fibers have an average fiber length less than about 2 mm.

9. The container of claim 1 wherein the fibers have an average aspect ratio in the range of 5:1 to 25:1.

10. The container of claim 1 further comprising filler material.

11. The container of claim 10 wherein the filler material comprises calcium carbonate, silica, calcium sulfate hydrate, magnesium silicate, micaceous minerals, clay minerals, titanium dioxide or talc.

12. The container of claim 10 further comprising short fibers, wherein filler material and/or short fibers have a combined concentration less than 25% by dry weight of the container.

13. The container of claim 1 further comprising a wax or wax emulsion.

14. The container of claim 1 further comprising a fiber sizing agent, wherein the fiber sizing agent forms a coating on at least a portion of the surface of at least a portion of the fibers to serve as an adhesion promoter, to protect the surface of the fibers from damage, as an aid in handling, to add strength or stiffness to the fiber, or to reduce absorbency.

15. The container of claim 14 wherein the fiber sizing agent comprises alkylketene dimer emulsion, alkenyl succinic anhydride, styrene acrylate copolymer or alkylated melamine.

16. The container of claim 1 further comprising a mold release agent.

17. The container of claim 16 wherein the mold release agent comprises magnesium stearate, talc, fats or oils.

18. The edible non-human animal food container of claim 1, further comprising a protein or a polymer, wherein the protein or polymer reduces the brittleness of the edible non-human animal food container.

19. The edible non-human animal food container of claim 1, further comprising a second protein to improve the mechanical properties of the edible non-human animal food container when dry.

20. The edible non-human animal food container of claim 19, wherein the second protein is albumen or gelatin.

21. The edible non-human animal food container of claim 1, further comprising a coloring agent, a scenting agent, a flavoring agent, a pest control agent, a vitamin, food grade materials, or combinations thereof.

22. The edible non-human animal food container of claim 1, further comprising proteins or nutrients tuned to the specific stages of a non-human animal's life.

23. The edible non-human animal food container of claim 22, wherein the non-human animal is a dog.

24. The edible non-human animal food container of claim 1, wherein the edible non-human animal container is of a shape of a bone, a fish, or a rodent.

25. The container of claim 1, wherein the starch is a water-resistant starch.

26. The container of claim 25, wherein the water-resistant starch comprises a high-amylose starch, alkenyl succinic anhydride modified starch, acetic anhydride modified starch, vinyl acetate modified starch, acrolein modified starch, epichlorohydrin modified starch, phosphorus oxychloride modified starch, sodium trimetaphosphate modified starch, or propylene oxide modified starch or a combination thereof.

27. A method for preparing a pre-packaged non-human animal feeding article with food comprising:
providing an edible non-human animal food container comprising starch, water, and processed fibrous material;
adding a quantity of cooked or uncooked pet food to the container;
cooking or processing the container together with the pet food; and
packaging the cooked container with pet food in a plastic bag thus sterilizing and sealing both the container and food together to avoid contamination.

28. The method for preparing a pre-packaged non-human animal feeding article of claim 27, wherein the container further comprises a wax, a wax emulsion, a mold-releasing agent, a coloring agent, a scenting agent, a flavoring agent, a pest control agent, a vitamin, or combinations thereof.

29. The method for preparing a pre-packaged non-human animal feeding article of claim 27, wherein the container is in a shape of a bone, a fish, or a rodent.

30. The method for preparing a pre-packaged non-human animal feeding article of claim 27, wherein the container further comprises proteins or nutrients tuned to the specific stages of a non-human animal's life.

31. The method for preparing a pre-packaged non-human animal feeding article of claim 27, wherein the non-human animal is a dog.

32. A pre-packaged non-human animal feeding article prepared according to claim 27, comprising, a quantity of non-human animal food contained within the edible non-human animal food container; and a packaging material.

33. An edible non-human animal food container comprising
a biodegradable fiber component in an amount ranging from about 5% to about 40% on a dry weight basis;
a starch component in an amount ranging from about 40% to about 94.5% on a dry weight basis; and,
an additive component in an amount ranging from more than 0% to about 15% on a dry weight basis, wherein the additive component comprises an epoxidized vegetable oil, a hydrogenated triglyceride, poly(vinyl acetate), poly(vinyl acetate-ethylene) copolymer, poly(ethylene-vinyl acetate) copolymer, or a combination thereof.
wherein the edible non-human animal container is of a shape that is attractive to a non-human animal and further comprises a flavoring agent that is attractive to a non-human animal.

34. The container of claim 33, wherein the biodegradable fiber component comprises a natural fiber, and the natural fiber comprises a woody fiber, a non-woody fiber, or an animal fiber.

35. The container of claim 33, wherein the biodegradable fiber component comprises a biodegradable synthetic fiber.

36. The container of claim 33, wherein the starch component comprises an organic filler material having a ratio of starch to filler that ranges from about 10:1 to about 1:1.

37. The container of claim 33, wherein the additive is present in an amount ranging from about 2% to about 5%.

38. The container of claim 33, wherein the additive component is a polymer selected from the group consisting of poly(vinyl acetate), poly(vinyl acetate-ethylene) copolymer, and poly(ethylene-vinyl acetate) copolymer.

39. An aqueous mixture for making the container of claim 33, wherein the mixture contains water in a quantity sufficient to allow for shaping of the composition into a form that creates a biodegradable, disposable, and water-resistant article of manufacture when heated at a sufficient temperature and for a sufficient time.

40. The aqueous mixture of claim 39 comprising from about 40% to about 80% water.

41. The aqueous mixture of claim 39, wherein the starch component comprises a combination of native starch and pre-gelatinized starch, and the ratio of the fiber to pre-gelatinized starch ranges from about 1.5:1 to about 3:1.

42. The aqueous mixture of claim 40 further comprising magnesium stearate, a wax, a cross-linking agent, or a combination thereof.

43. The container of claim 33, wherein at least a portion of the starch component can be comprised of one or more water-resistant starches.

44. The container of claim 43, wherein the water-resistant starch component comprises a high-amylose starch, alkenyl succinic anhydride modified starch, acetic anhydride modified starch, vinyl acetate modified starch, acrolein modified starch, epichlorohydrin modified starch, phosphorus oxychloride modified starch, sodium trimetaphosphate modified starch, or propylene oxide modified starch or a combination thereof.

45. The container of claim 33, wherein the additive is present in an amount ranging from about 1.5% to about 7%.

46. The edible non-human animal food container of claim 33, further comprising a protein or a polymer, wherein the protein or polymer reduces the brittleness of the edible non-human animal food container.

47. The edible non-human animal food container of claim 33, further comprising a wax, a wax emulsion, a mold-releasing agent, a coloring agent, a scenting agent, a flavoring agent, a pest control agent, a vitamin, or combinations thereof.

48. The edible non-human animal food container of claim 33, further comprising proteins or nutrients tuned to the specific stages of a non-human animal's life.

49. The edible non-human animal food container of claim 48, wherein the non-human animal is a dog.

50. The edible non-human animal food container of claim 33, wherein the edible non-human animal container is of a shape of a bone, a fish, or a rodent.
